(19) United States
(12) Patent Application Publication
(10) Pub. No.: US 2025/0303723 A1
(43) Pub. Date: Oct. 2, 2025

(54) INK REPLENISHMENT CONTAINER

(71) Applicant: SEIKO EPSOON CORPORATION, Tokyo (JP)

(72) Inventors: Tadahiro MIZUTANI, Shiojiri-shi (JP); Tadashi WATANABE, Matsumoto-shi (JP); Yuta KOIKE, Matsumoto-shi (JP); Seigo MIYAZAWA, Shiojiri-shi (JP); Hiroyoshi OZEKI, Shiojiri-shi (JP); Yoshihiro KOIZUMI, Shiojiri-shi (JP); Atsushi KOBAYASHI, Matsumoto-shi (JP)

(73) Assignee: SEIKO EPSOON CORPORATION, Tokyo (JP)

(21) Appl. No.: 19/090,829

(22) Filed: Mar. 26, 2025

(30) Foreign Application Priority Data
Mar. 27, 2024 (JP) 2024-050635

(51) Int. Cl. B41J 2/175

(52) U.S. Cl. CPC B41J 2/17506; B41J 2/1754

(57) ABSTRACT

An ink replenishment container for supplying ink to an ink ejection apparatus includes: a container body configured to contain the ink; an ink outlet portion coupled to the container body and including an ink outlet through which the ink flows out; and a cap that is attached to the ink outlet portion and covers the ink outlet. At least one of the container body, the ink outlet portion, and the cap is composed of a recycled resin material having a black-based color.

The present application is based on, and claims priority from JP Application Serial Number 2024-050635, filed Mar. 27, 2024, the disclosure of which is hereby incorporated by reference herein in its entirety.

### BACKGROUND

### 1. Technical Field

The present disclosure relates to an ink replenishment container.

### 2. Related Art

In the related art, ink replenishment containers for supplying ink to ink ejection apparatuses such as ink jet printers are used. In addition, various proposals have been made for recycling such ink replenishment containers. JP-A-2022-129862 proposes a liquid replenishment container including a liquid containing portion, a pouring portion coupled to the liquid containing portion, and a cap portion configured to be attached to the pouring portion, in which the liquid containing portion is composed of metal suitable for recycling. In addition, JP-A-2022-129862 proposes that in order to prevent the pouring portion from being erroneously removed from the liquid containing portion when the cap portion is removed from the pouring portion, the cap portion have a different type of color from the color of the liquid containing portion, and the pouring portion and the ink containing portion have the same type of color. Specifically, JP-A-2022-129862 proposes that the pouring portion be gray, and the cap portion be white because the liquid containing portion composed of metal is typically gray. JP-A-2018-034877 proposes a bottle set for supplying ink, including a container member, a nozzle member, and a lid member, in which at least a part of the lid member is colored so as to have the same type of color as the color of the ink contained in the container member.

In the liquid replenishment container in JP-A-2022-129862, when a recycled resin material is used for the cap portion, it is necessary to color the cap portion in order to obtain the white cap portion because various kinds of resin materials are kneaded in the manufacturing process of recycled resin materials. In the bottle set for supplying ink in JP-A-2018-034877, cap portions of various colors corresponding to ink colors are used. Hence, when the cap portions are recycled and used as recycled materials, it is necessary to classify and collect the cap portions for each color in order to obtain cap portions in colors corresponding to ink colors while reducing coloring work. Hence, there is room for improvement in recycling of the cap portions. In view of the above, an ink replenishment container is desired that is suitable for recycling on the premise that different kinds of materials are kneaded when recycled, while reducing environmental load by using recycled resin materials.

### SUMMARY

An aspect of the present disclosure provides an ink replenishment container for supplying ink to an ink ejection apparatus. The ink replenishment container includes: a container body configured to contain the ink; an ink outlet portion coupled to the container body and including an ink outlet through which the ink flows out; and a cap that is attached to the ink outlet portion and covers the ink outlet, and at least one of the container body, the ink outlet portion, and the cap is composed of a recycled resin material having a black-based color.

### BRIEF DESCRIPTION OF THE DRAWINGS

FIG. 1 is a perspective view of an ink ejection apparatus according to a first embodiment.

FIG. 2 is a perspective view showing a state in which ink is supplied to an ink tank by using an ink replenishment container.

FIG. 3 is an exploded perspective view of the ink replenishment container.

FIG. 4 is a front view of the ink replenishment container.

FIG. 5 is a front view schematically showing the ink replenishment container in the first embodiment.

FIG. 6 is a front view schematically showing an ink replenishment container according to a second embodiment.

FIG. 7 is a front view schematically showing an ink replenishment container according to a third embodiment.

FIG. 8 is a front view schematically showing an ink replenishment container according to a fourth embodiment.

FIG. 9 is a front view schematically showing an ink replenishment container according to a fifth embodiment.

### DESCRIPTION OF EMBODIMENTS

### A. First Embodiment

### A1. Schematic Configurations of Ink Ejection Apparatus 100 and Ink Replenishment Container 200:

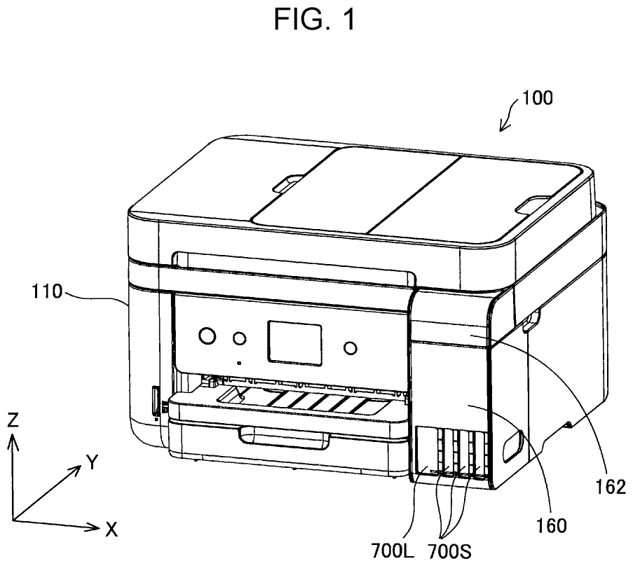

FIG. 1 is a perspective view of an ink ejection apparatus 100 according to a first embodiment. In the present embodiment, the ink ejection apparatus 100 is an ink jet printer which performs printing by ejecting ink onto a printing medium. The ink ejection apparatus 100 is not limited to an ink jet printer and may be configured as any type of apparatus capable of ejecting ink onto a medium. XYZ axes orthogonal to one another are shown in FIG. 1. The X axis corresponds to the width direction of the ink ejection apparatus 100, the Y axis corresponds to the depth direction of the ink ejection apparatus 100, and the Z axis corresponds to the height direction of the ink ejection apparatus 100. The ink ejection apparatus 100 is installed on a horizontal installation surface defined by the X-axis direction and the Y-axis direction. Note that the “X-axis direction” means a concept including the +X direction and the −X direction. Similarly, the “Y-axis direction” means a concept including the +Y direction and the −Y direction, and the “Z-axis direction” means a concept including the +Z direction and the −Z direction.

The ink ejection apparatus 100 includes a housing 110. Inside the housing 110, a carriage (not shown) movable in the X-axis direction corresponding to the main scanning direction is provided. The carriage is provided with a print head (not shown) for ejecting ink onto a print medium. An ink tank housing unit 160 that houses a plurality of ink tanks 700S and 700L is provided at one end of the front surface of the housing 110. The ink tank housing unit 160 has a lid 162, which can be opened and closed, at an upper portion thereof. The ink tanks 700S are small-capacity tanks, and the ink tank 700L is a large-capacity tank. However, in the following description, both are simply referred to as “an ink tank 700” or “ink tanks 700” without distinction. Each ink tank 700 is coupled to the print head of the carriage by a tube (not shown). In other words, the ink tanks 700 are stationary ink tanks which are not mounted on the carriage of the ink ejection apparatus 100. In addition, each ink tank 700 is an ink-replenishment ink tank in which ink is manually supplied from an ink replenishment container 200 to be described later by a user when the amount of remaining ink has become low. Although the ink tanks 700 are stationary ink tanks in this embodiment, they may be ones mounted on the carriage of the ink ejection apparatus 100.

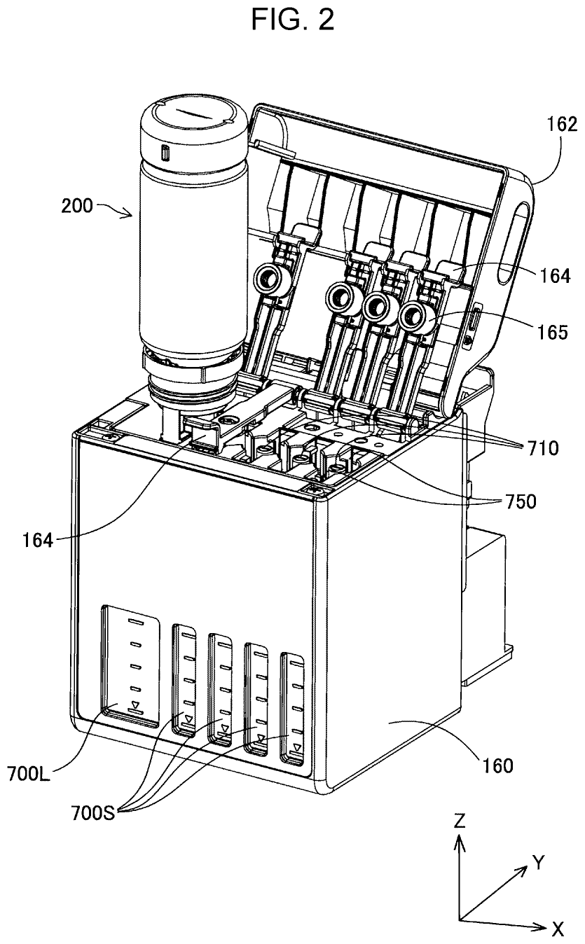

FIG. 2 is a perspective view illustrating a state (hereinafter also referred to as an “ink replenishing state”) in which ink is being supplied to an ink tank 700 by using the ink replenishment container 200. The front surface of each ink tank 700 is formed of a transparent member, and the amount of remaining ink in each ink tank 700 can be viewed from the outside. When the amount of remaining ink has become low, the user can open the lid 162 as shown in FIG. 2 and supply ink through an ink inlet flow-path member 710 of the ink tank 700.

The ink inlet flow-path member 710 in a cylindrical shape for supplying ink to the ink tank 700 is provided on the upper surface of each ink tank 700. The ink tank housing unit 160 is provided with sealing cap members 164 each having a sealing cap 165 for sealing the distal end of the ink inlet flow-path member 710. In a state in which ink is not supplied to the ink tank 700, the distal end of the ink inlet flow-path member 710 is sealed by the sealing cap 165 of the sealing cap member 164. When the user replenishes the ink tank 700 with ink, the user removes the sealing cap member 164 from the ink inlet flow-path member 710, inserts the distal end portion of the ink replenishment container 200 at the position of the ink inlet flow-path member 710, and replenishes the ink tank 700 with ink. On the periphery of the ink inlet flow-path member 710, two recessed portions 750 to be fitted to fitting portions (described later) included in the ink replenishment container 200 are provided. These recessed portions 750 have a 180-degree rotationally symmetric shape around the ink inlet flow-path member 710.

In the present specification, the term “ink replenishment” means an operation of increasing the amount of remaining ink by supplying ink to the ink tank 700. However, it is not necessary to fill the ink tank 700 with ink by the “ink replenishment”. The “ink replenishment” also includes an operation of supplying an empty ink tank 700 with ink when the ink ejection apparatus 100 is used for the first time.

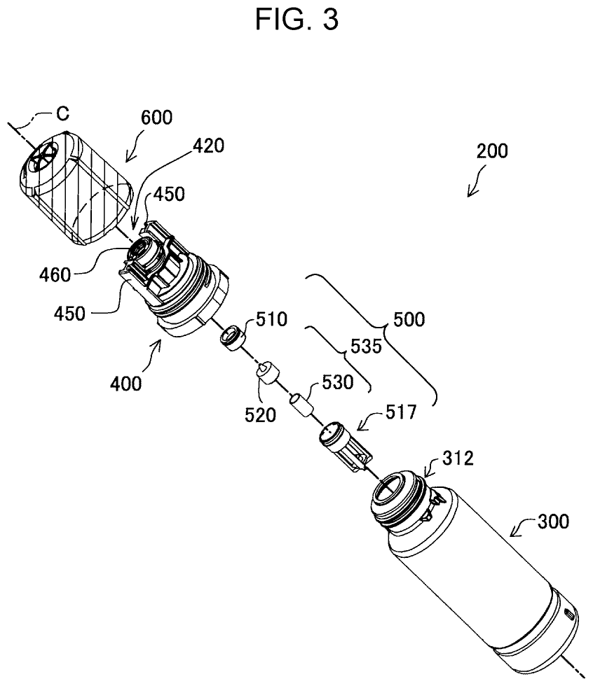

FIG. 3 is an exploded perspective view of the ink replenishment container 200 according to the first embodiment. The ink replenishment container 200 includes a container body 300 configured to contain ink, an ink outlet portion 400 coupled to the container body 300 and having an ink outlet 460 through which ink flows out, an outlet valve unit 500, and a cap 600. An upper end side of the ink replenishment container 200 which is the cap 600 side is referred to as a “front end side”, and a lower end side which is the container body 300 side is referred to as a “rear end side”. The container body 300 is a hollow cylindrical container having an opening on the front end side. A small-diameter portion 312 having a smaller outer diameter than other portions of the container body 300 is provided at the front end of the container body 300. An external thread for attaching the ink outlet portion 400 is formed on the outer peripheral surface of the small-diameter portion 312. In the present disclosure, a direction parallel to a central axis C of the ink replenishment container 200 is referred to as an “axial direction”, and a direction outward from the central axis C is referred to as a “radial direction”.

The ink outlet 460 is provided at the front end of the ink outlet portion 400. The ink outlet portion 400 is coupled to the container body 300. The ink outlet portion 400 is provided with a cylindrical portion 420 having the ink outlet 460. The outlet valve unit 500 is attached in the cylindrical portion 420. The outlet valve unit 500 is attached in the cylindrical portion 420 such that a radial gap is present between the outlet valve unit 500 and the inner peripheral surface of the cylindrical portion 420. When the ink is supplied to the ink tank 700, the ink inlet flow-path member 710 (FIG. 2) of the ink tank 700 is inserted into the ink outlet 460.

In the ink outlet portion 400, two fitting portions 450 are provided around the ink outlet 460. These fitting portions 450 are positioning members for positioning the ink replenishment container 200 by being fitted into the recessed portions 750 (FIG. 2) provided around the ink inlet flow-path member 710 of the ink tank 700. The positioning means, for example, at least one of the two functions: a function of preventing erroneous supply of ink that allows the ink replenishment container 200 for supplying yellow ink to be fitted into the recessed portions 750 corresponding to the ink tank 700 containing yellow ink and that prevents the ink replenishment containers 200 for supplying other color inks such as magenta ink and cyan ink from being fitted, and a function of stabilizing the orientation of the ink replenishment container when ink is being supplied. The function of preventing erroneous supply of ink also means a function of preventing erroneous supply not only in terms of the color of ink but also, for example, in terms of distinction between dye ink and pigment ink for black ink. In the present embodiment, the two fitting portions 450 have a 180-degree rotationally symmetric shape around the central axis C of the ink replenishment container 200. Similarly, the recessed portions 750 provided around the ink inlet flow-path member 710 of the ink tank 700 has a 180-degree rotationally symmetric shape around the ink inlet flow-path member 710. In the ink replenishing state, by fitting the fitting portions 450 of the ink replenishment container 200 into the recessed portions 750 around the ink inlet flow-path member 710, the orientation of the ink replenishment container 200 is limited to two orientations that are rotationally symmetric by 180 degrees. Hence, it is possible to maintain the ink replenishment container 200 in a stable orientation during ink replenishment. However, the fitting portions 450 are optional.

The outlet valve unit 500 is configured to seal the ink outlet 460 to prevent ink from leaking to the outside in a non-replenishing state in which the ink is not being supplied to the ink tank 700, and is configured to release the sealing to allow ink to flow into the ink inlet flow-path member 710 in the ink replenishing state in which ink is being supplied to the ink tank 700.

As shown in FIG. 3, the outlet valve unit 500 includes a valve housing 517, a sealing member 510, and a spring valve 535. The valve housing 517 is engaged with the cylindrical portion 420. The valve housing 517 houses the sealing member 510 in a cylindrical portion on the front end side of the valve housing 517 such that the sealing member 510 will not come off. The valve housing 517 houses a spring member 530, which will be described later, on the rear end side.

The spring valve 535 includes a valve body 520 and the spring member 530. The spring member 530 urges the valve body 520 in the axial direction toward the ink outlet 460. The spring member 530 can be composed of, for example, metal. In the present embodiment, the spring member 530 is a coil spring. The valve body 520 is attached in the valve housing 517 so as to be axially movable. In the non-replenishing state, the valve body 520 is urged toward the sealing member 510 by the spring member 530. The valve body 520 is brought into contact with the sealing member 510 by the urging, whereby an ink flow path (not shown) in the ink outlet portion 400 is closed. In contrast, in the ink replenishing state, the ink inlet flow-path member 710 is inserted into the ink outlet 460, and the valve body 520 is pressed and moved by the ink inlet flow-path member 710 in a direction opposite to the urging direction of the spring member 530, that is, toward the rear end side in the axial direction. By the movement of the valve body 520, the closed ink flow path in the ink outlet portion 400 is opened, and the ink in the container body 300 is supplied to the ink tank 700 through the ink outlet 460 and the ink inlet flow-path member 710.

The cap 600 is detachably attached to the ink outlet portion 400 and covers the ink outlet 460. As shown in FIG. 2, in the ink replenishing state, the cap 600 is removed from the ink outlet portion 400. In the non-replenishing state, the cap 600 is typically attached to the ink outlet portion 400.

### A2. Colors and Materials of Components of Ink Replenishment Container 200:

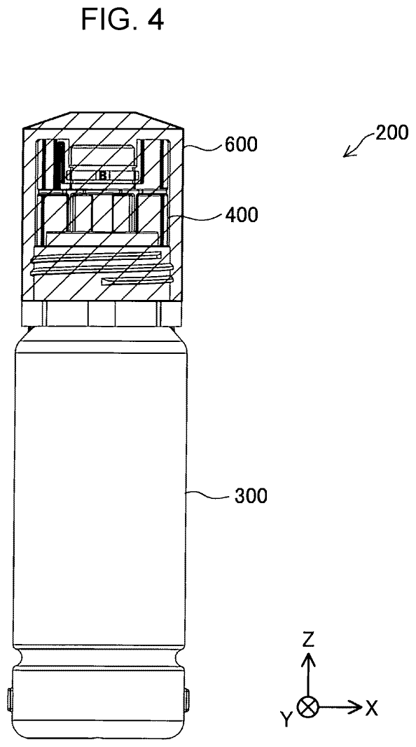

FIG. 4 is a front view of the ink replenishment container 200. FIG. 4 is a front view of the ink replenishment container 200 in an upright position with the cap 600 attached to the ink outlet portion 400. The “upright position of the ink replenishment container 200” means a state in which the ink replenishment container 200 is placed on a horizontal surface such as a desk with the bottom portion of the container body 300 facing downward. As shown in FIG. 2 described above, ink is supplied to the ink tank 700 in an inverted posture in which the front end side of the ink replenishment container 200 faces downward. The ink replenishment container 200 is configured such that mainly the container body 300, the ink outlet portion 400, and the cap 600 are visible from the outside. In this embodiment, even in a state in which the cap 600 is attached to the ink outlet portion 400, the ink outlet portion 400 is visible through the cap 600 as shown in FIG. 4. The color and material of each component of the container body 300, the ink outlet portion 400, and the cap 600 will be described below.

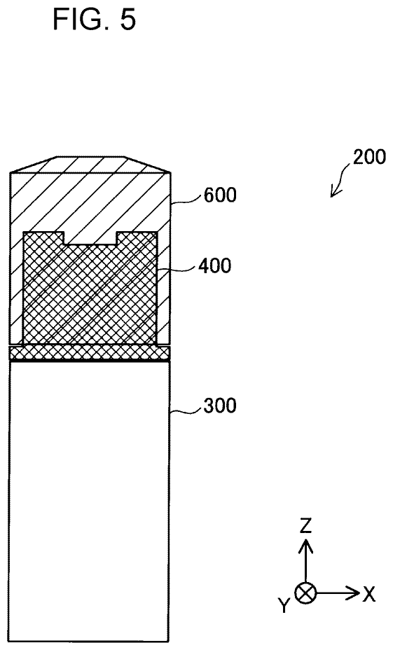

FIG. 5 is a front view schematically showing the ink replenishment container 200 according to the first embodiment. In this embodiment, the ink outlet portion 400 is composed of a recycled resin material having a black-based color and not having optical transparency. In the present embodiment, the cap 600 is composed of a recycled resin material having a black-based color and optical transparency. In FIG. 5 and the subsequent figures, recycled resin materials having a black-based color and not having optical transparency are indicated by fine cross hatching, and recycled resin materials having a black-based color and optical transparency are indicated by single hatching with wide intervals.

The term “black-based color” mentioned above means an achromatic color having an L* value of 0 or more and less than 50 in the L*a*b* color system in the CIE color system. Since the ink outlet portion 400 and the cap 600 have such colors, when at least one of the ink outlet portion 400 and the cap 600 is recycled, and even if it is kneaded with a different kind of material when recycled, the obtained member can be reused without being colored, or even if the member is colored, the possibility that the obtained member can be reused by adding a small amount of colorant can increase. In addition, since a black-based color is an achromatic color, the color is likely to be stable easily, and it is possible to reduce the variation in the color of recycled components. Also in this respect, it is possible to reduce coloring of recycled material.

The “black-based color” may be an achromatic color having an L* value of 0 or more and less than 10 in the L*a*b* color system in the CIE color system. With such a color, at least one of the ink outlet portion 400 and the cap 600 can be composed of a recycled resin material in black or dark gray close to black. Hence, even if at least one of the ink outlet portion 400 and the cap 600 is kneaded with a different kind of material when recycled, it is possible to increase the possibility that the obtained member can be reused without being colored or can be reused by adding a small amount of colorant even if the member is colored.

The colors of the ink outlet portion 400 and the cap 600 can be identified, for example, by measuring the L* value of the L*a*b* color system using a colorimeter such as i1 Basic Pro 2 available from X-Rite, Inc. In this measurement, a piece having a relatively flat surface with a size equal to or larger than a predetermined threshold value may be cut out from the ink outlet portion 400 and the cap 600, and the color measurement may be performed on the cut piece.

The term “recycled resin material” mentioned above means a resin material at least a part of which is composed of a recycled material. For example, such resin material corresponds to materials produced by recycling and kneading various resin materials such as polypropylene (PP), polyethylene (PE), polyethylene terephthalate (PET), polyamide (PA), nylon, and polystyrene (PS). Whether or not the ink outlet portion 400 or the cap 600 is composed of a recycled resin material can be determined, for example, as follows. Component analysis is performed on the ink outlet portion 400 and the cap 600 by using a known component analyzer, and when the result shows that a plurality of types of resin are mixed, it can be determined that the material is a recycled resin material, and when only a single resin is detected, it can be determined that the material is not a recycled resin material.

Since the resin material composing the cap 600 has optical transparency, even in a state where the cap 600 is attached as shown in FIGS. 4 and 5, the inner side surface of the cap 600 and the ink outlet portion 400 are visible from the outside. Thus, the user can realize in advance that ink is attached to the inner surface of the cap 600 or the ink outlet portion 400, and can carefully remove the cap 600 so that the ink will not drip or hands are not stained with the ink.

In the present embodiment, the container body 300 is composed of a resin material having optical transparency and colored in a color similar to the ink color. Hence, the user can visually recognize the amount of remaining ink in the ink replenishment container 200 in the upright position from the outside. In order to visually recognize the amount of remaining ink, the container body 300 needs only to be composed of a resin material having optical transparency. However, since at least one of the cap 600 and the ink outlet portion 400 has a black-based color, when the container body 300 is colored in a color similar to the ink color, the user can easily recognize the ink color, and this improves the convenience.

According to the ink replenishment container 200 of the first embodiment described above, since the ink outlet portion 400 and the cap 600 are composed of recycled resin materials, it is possible to contribute to reduction in environmental load. In addition, since the ink outlet portion 400 and the cap 600 are composed of a recycled resin material having a black-based color, even if these members are kneaded with a different kind of material when recycled, it is possible to increase the possibility that obtained members can be reused without being colored. Hence, the ink replenishment container 200 of the first embodiment is suitable for recycling on the premise that different types of materials are kneaded when recycled, while reducing environmental load by being composed of recycled resin materials.

In addition, according to the ink replenishment container 200 of the first embodiment, since the ink outlet portion 400 and the cap 600 have an achromatic color with an L* value of 0 or more and less than 50 in the L*a*b* color system in the CIE color system, the ink outlet portion 400 and the cap 600 can be composed of a black or gray recycled resin material. Hence, even if a member composed of a recycled resin material is kneaded with a different kind of material when recycled, it is possible to increase the possibility that the obtained member can be reused without being colored or can be reused by adding a small amount of colorant even if the member is colored.

In addition, according to the ink replenishment container 200 of the first embodiment, since the cap 600 which is easily separated from the ink replenishment container 200 and easily used as a recycled material is composed of a recycled resin material having a black-based color, it is possible to reduce sorting or coloring, and it is possible to recycle the cap 600 more easily.

In addition, according to the ink replenishment container 200 of the first embodiment, since the cap 600 is composed of a recycled resin material having a black-based color and optical transparency, it is easy for the user to visually recognize through the cap 600 that ink is attached to the outer surface of the ink outlet portion 400. This makes it easy to call attention to ink contamination when the user opens the cap 600. In particular, ink having high chroma can be easily viewed from the outside even through a semi-transparent cap having a black-based color.

In addition, according to the ink replenishment container 200 of the first embodiment, since the ink outlet portion 400 is composed of a recycled resin material having a black-based color, the ink outlet portion 400 is suitable for recycling.

### B. Second Embodiment

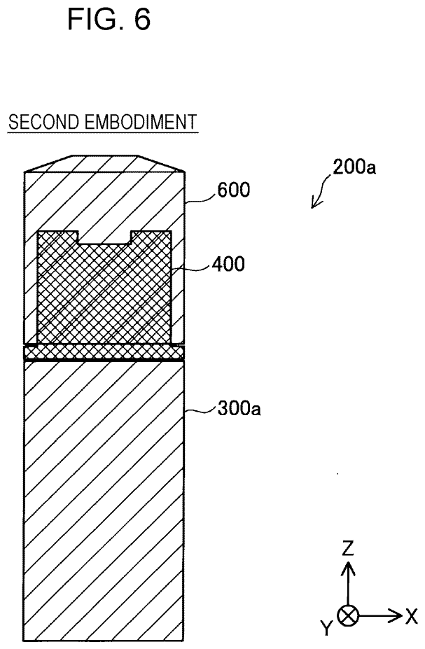

FIG. 6 is a front view schematically showing an ink replenishment container 200a according to a second embodiment. The ink replenishment container 200a of the second embodiment is different from the ink replenishment container 200 of the first embodiment only in that the ink replenishment container 200a includes a container body 300a instead of the container body 300. In the ink replenishment container 200a of the second embodiment, the same components as those of the ink replenishment container 200 of the first embodiment are denoted by the same symbols, and detailed description thereof will be omitted.

Similarly to the cap 600, the container body 300a of the ink replenishment container 200a of the second embodiment is composed of a recycled resin material having a black-based color and optical transparency. Both the terms “black-based color” and “recycled resin material” have the same meaning as the terms “black-based color” and “recycled resin material” explained in the first embodiment. However, the color of the container body 300a and the color of the cap 600 need not be exactly the same but may be exactly the same. In addition, the container body 300a and the cap 600 may be composed of recycled resin materials having exactly the same components, but this is not essential.

The ink replenishment container 200a of the second embodiment described above has the same effects as the ink replenishment container 200 of the first embodiment. In addition, since the container body 300a is composed of a recycled resin material having a black-based color, it is easy to suppress deterioration of the ink contained in the container body 300a due to light such as ultraviolet rays. Further, since the container body 300a, which typically has a relatively large proportion of the entire ink replenishment container 200a, is composed of a recycled resin material having a black-based color, the percentage of recycled material use can be improved. In addition, when recycling, it is easy to increase the amount of recycled material used, and since the color is black-based, it is suitable for recycling.

Further, according to the ink replenishment container 200a of the second embodiment, since the container body 300a is composed of a recycled resin material having optical transparency, the amount of remaining ink contained in the container body 300a can be easily visually recognized from the outside. In addition, in the ink replenishment container 200a in an inverted state during an ink supply process, it is easy to visually recognize that the change in the liquid level in the container body 300a has stopped, and easy to recognize that the ink supply process has ended.

### C. Third Embodiment

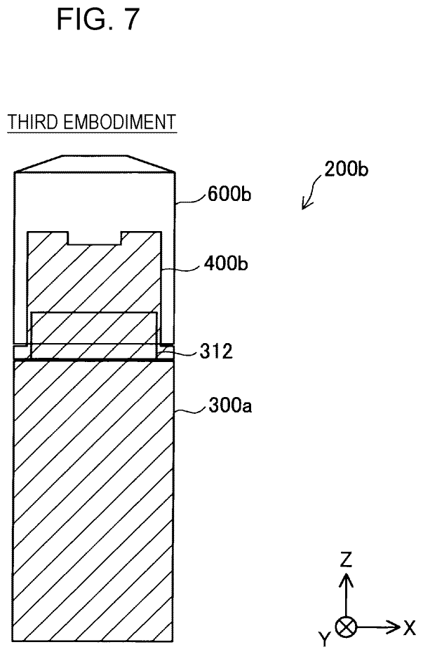

FIG. 7 is a front view schematically showing an ink replenishment container 200b according to a third embodiment. The ink replenishment container 200b of the third embodiment is different from the ink replenishment container 200a of the second embodiment in that the ink replenishment container 200b includes an ink outlet portion 400b instead of the ink outlet portion 400 and includes a cap 600b instead of the cap 600. In the ink replenishment container 200b of the third embodiment, the same components as those of the ink replenishment container 200a of the second embodiment are denoted by the same symbols, and detailed description thereof will be omitted.

The ink outlet portion 400b in the ink replenishment container 200b of the third embodiment is composed of a recycled resin material having a black-based color and optical transparency, similarly to the container body 300a. Both the terms “black-based color” and “recycled resin material” have the same meaning as the terms “black-based color” and “recycled resin material” explained in the first embodiment. However, the color of the container body 300a and the color of the ink outlet portion 400b need not be exactly the same but may be exactly the same. In addition, the container body 300a and the ink outlet portion 400b may be composed of recycled resin materials having exactly the same components, but this is not essential.

Similarly to the container body 300 of the first embodiment, the cap 600b of the third embodiment is composed of a resin material having optical transparency and colored in a color similar to the color of the ink contained in the container body 300a.

Since the cap 600b and the ink outlet portion 400b are composed of a resin material having optical transparency, the user can visually recognize the small-diameter portion 312 of the container body 300a in the upright position from the outside as shown in FIG. 7.

The ink replenishment container 200b of the third embodiment described above has the same effects as the ink replenishment container 200 of the first embodiment and the ink replenishment container 200a of the second embodiment. In addition, since the ink outlet portion 400b is composed of a resin material having optical transparency, even when the amount of remaining ink is reduced, and the ink liquid surface reaches the inside of the ink outlet portion 400b in the ink replenishing state, the ink liquid surface is visible from the outside. Hence, the user can easily check the amount of remaining ink.

### D. Fourth Embodiment

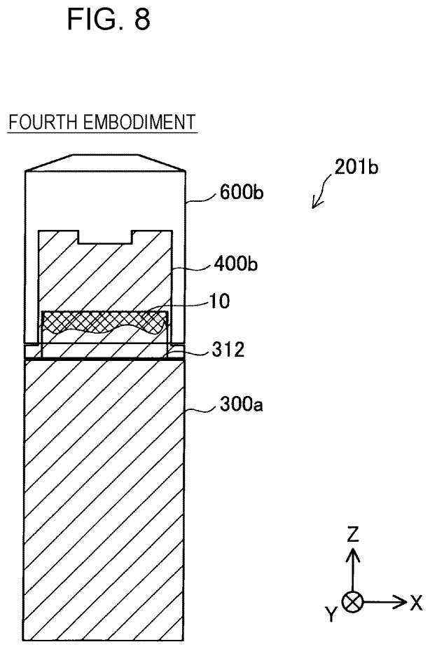

FIG. 8 is a front view schematically showing an ink replenishment container 201b according to a fourth embodiment. The ink replenishment container 201b of the fourth embodiment is different from the ink replenishment container 200b of the third embodiment only in that the ink replenishment container 201b includes a sealing member 10. In the ink replenishment container 201b of the fourth embodiment, the same components as those of the ink replenishment container 200b of the third embodiment are denoted by the same symbols, and detailed description thereof will be omitted.

The sealing member 10 is composed of a film-like resin member. The sealing member 10 is disposed so as to close the opening on the front end side of the small-diameter portion 312 in an unused state of the ink replenishment container 201b. Hence, even if the ink replenishment container 201b is put in a supply orientation with the opening being closed, ink cannot be supplied. Hence, the user needs to remove the sealing member 10 or make a cutout in the sealing member 10 at the time of first use. To be more specific, the user needs to remove the cap 600b and then remove the ink outlet portion 400b from the container body 300a to expose the sealing member 10 and the small-diameter portion 312, and then needs to pluck off the sealing member 10 by gripping its end portion or make a cutout in the sealing member 10.

Since the ink outlet portion 400b is composed of a resin material having optical transparency, the user can visually recognize the presence of the sealing member 10 from the outside through the ink outlet portion 400b in a state where the cap 600b is removed. Hence, the user can realize that ink cannot be supplied in this state and that the sealing member 10 needs to be removed or cut in.

The ink replenishment container 201b of the fourth embodiment described above has the same effects as the ink replenishment container 200b of the third embodiment. In addition, since the sealing member 10 is attached so as to close the opening of the small-diameter portion 312, it is possible to reduce ink evaporation in the unused state. Further, in the ink replenishment container 201b of the fourth embodiment, since the sealing member 10 is attached to the opening of the small-diameter portion 312 of the container body 300a, it is necessary to remove the sealing member 10 at the time of first use According to the ink replenishment container 201b of the fourth embodiment, since the ink outlet portion 400b is composed of a recycled resin material having optical transparency, it is possible for the user to easily visually recognize from the outside that the sealing member 10 is attached, making it easy to call the user's attention.

### E. Fifth Embodiment

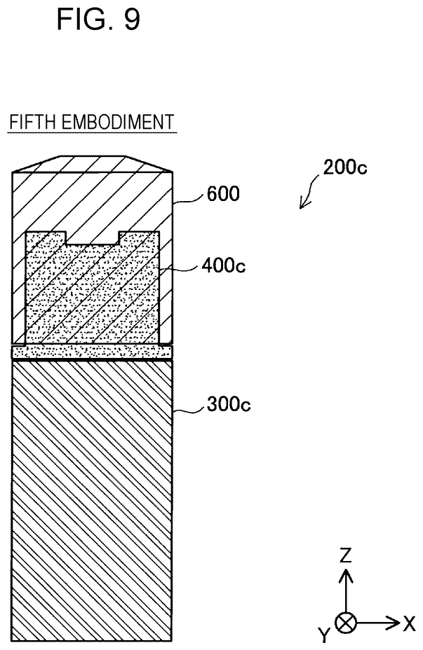

FIG. 9 is a front view schematically showing an ink replenishment container 200c according to a fifth embodiment. The ink replenishment container 200c of the fifth embodiment is different from the ink replenishment container 200 of the first embodiment in that the ink replenishment container 200c includes an ink outlet portion 400c instead of the ink outlet portion 400 and includes a container body 300c instead of the container body 300. In the ink replenishment container 200c of the fifth embodiment, the same components as those of the ink replenishment container 200 of the first embodiment are denoted by the same symbols, and detailed description thereof will be omitted.

The ink outlet portion 400c in the fifth embodiment is composed of a recycled resin material having a black-based color and not having optical transparency. The “black-based color” of the ink outlet portion 400c of the fifth embodiment is a color corresponding to so-called “gray”. For example, the color may be a color having an L* value of 40 or more and less than 50 in the L*a*b* color system in the CIE color system.

The container body 300c of the fifth embodiment is different from the container body 300 of the first embodiment only in that the container body 300c is composed of metal For example, the container body 300c may be composed of a metal such as an aluminum alloy or stainless steel. Since the container body 300c is composed of metal, it is easy to suppress deterioration of the ink contained in the container body 300c due to light such as ultraviolet rays. In addition, since the ink outlet portion 400 also has a gray color, the ink outlet portion 400, together with the container body 300c, makes it easier to suppress deterioration of the ink due to light such as ultraviolet rays. In addition, the container body 300c can be easily recycled as a metal material.

As described above, the ink outlet portion 400c has a gray color. The container body 300c is composed of metal, and the outer surface of the container body 300c is grayish. Since the ink outlet portion 400c and the container body 300c have colors similar to each other, it is easy for the user to recognize that the members need not be detached from each other.

The ink replenishment container 200c of the fifth embodiment described above has the same effects as the ink replenishment container 200 of the first embodiment. In addition, since the ink outlet portion 400c is gray among black-based colors, the color of the ink outlet portion 400c can be similar to the color of the container body 300c composed of metal, and hence, it is easy to distinguish between the cap 600 which needs to be removed from the container body 300c and the ink outlet portion 400c which need not be removed. In addition, since the ink outlet portion 400c is gray, it is easier to visually recognize the adhesion of ink with high chroma than in a configuration in which the ink outlet portion is black. In addition, since the ink outlet portion 400c is gray and has a color similar to the color of a typical recycled resin material (the color before coloring), the ink outlet portion 400c can be produced without coloring, and the ink outlet portion 400c can be easily reused.

### F. Other Embodiments

(F1) In the first embodiment, the cap 600 may be composed of a recycled resin material having a black-based color and not having optical transparency. In addition, in the first embodiment, the ink outlet portion 400 may be composed of a recycled resin material having a black-based color and optical transparency.

(F2) In the second embodiment, at least one of the cap 600 and the container body 300a may be composed of a recycled resin material having a black-based color and not having optical transparency.

(F3) In the third embodiment, at least one of the ink outlet portion 400b and the container body 300a may be composed of a recycled resin material having a black-based color and not having optical transparency. In the fourth embodiment, the container body 300a may be composed of a recycled resin material having a black-based color and not having optical transparency.

(F4) In the fifth embodiment, the cap 600 may be composed of a recycled resin material having a black-based color and not having optical transparency. In addition, the container body 300c may be composed of a recycled resin material having a black-based color, more specifically, a gray color. In such a configuration, the container body 300c may be composed of a recycled resin material having a gray color and having optical transparency.

(F5) In each of the embodiments, the caps 600 and 600b, the ink outlet portions 400, 400b, and 400c, and the container bodies 300, 300a, and 300c may all be composed of a recycled resin material having a black-based color and not having optical transparency. In addition, in each of the embodiments, the caps 600 and 600b, the ink outlet portions 400, 400b, and 400c, and the container bodies 300, 300a, and 300c may all be composed of a recycled resin material having a black-based color and optical transparency. In addition, in each of the embodiments, configurations in which the caps 600 and 600b and the ink outlet portions 400, 400b, and 400c are all composed of a recycled resin material having a black-based color and optical transparency, and in which the container bodies 300, 300a, and 300c are all composed of a recycled resin material having a black-based color and not having optical transparency are possible. In each of the embodiments, configurations in which one item out of the caps 600 and 600b, the ink outlet portions 400, 400b, and 400c, and the container bodies 300, 300a, and 300c is composed of a recycled resin material having a black-based color and not having optical transparency or a recycled resin material having a black-based color and optical transparency, and in which the other two items are composed of any color and material are possible. In other words, in general, an ink replenishment container in which at least one item out of the container bodies 300, 300a, and 300c, the ink outlet portions 400, 400b, and 400c, and the caps 600 and 600b is composed of a recycled resin material having a black-based color is applied as the ink replenishment container of the present disclosure.

The present disclosure is not limited to the above-described embodiments and can be implemented in various aspects without departing from the spirit of the present disclosure. For example, the present disclosure can also be implemented in the following aspects. Technical features in the above embodiments corresponding to technical features in the aspects described below can be appropriately replaced or combined in order to solve some or all of the issues in the present disclosure, or to achieve some or all of the effects of the present disclosure. In addition, when a technical feature is not described as an essential one in the present specification, the technical feature can be appropriately omitted.

### G. Other Aspects

(1) An aspect of the present disclosure provides an ink replenishment container for supplying ink to an ink ejection apparatus. The ink replenishment container may include: a container body configured to contain the ink; an ink outlet portion coupled to the container body and including an ink outlet through which the ink flows out; and a cap that is attached to the ink outlet portion and covers the ink outlet, and at least one of the container body, the ink outlet portion, and the cap may be composed of a recycled resin material having a black-based color.

According to the ink replenishment container of this aspect, since at least one of the container body, the ink outlet portion, and the cap is composed of a recycled resin material, it is possible to contribute to reduction in environmental load. In addition, since at least one of the container body, the ink outlet portion, and the cap is composed of a recycled resin material having a black-based color, it is possible to increase the possibility that even if a member composed of a recycled resin material is kneaded with a different material when recycled, an obtained member can be reused without being colored. Hence, the ink replenishment container of this aspect is suitable for recycling on the premise that different types of materials are kneaded when recycled, while reducing environmental load by being composed of recycled resin materials.

(2) In the ink replenishment container of the above aspect, the black-based color may be an achromatic color having an L* value of 0 or more and less than 50 in an L*a*b* color system in a CIE color system.

According to the ink replenishment container of this aspect, since at least one of the container body, the ink outlet portion, and the cap can be composed of a black or gray recycled resin material, even if the member composed of a recycled resin material is kneaded with a different material when recycled, the possibility that an obtained member can be reused without being colored, or even if the member is colored, the possibility that the member can be reused by adding a small amount of colorant is high.

(3) In the ink replenishment container of the above aspect, the black-based color may be an achromatic color having an L* value of 0 or more and less than 10 in the L*a*b* color system in the CIE color system.

According to the ink replenishment container of this aspect, since at least one of the container body, the ink outlet portion, and the cap can be composed of a recycled resin material in black or dark gray close to black, even if the member composed of a recycled resin material is kneaded with a different material when recycled, the possibility that an obtained member can be reused without being colored, or even if the member is colored, the possibility that the member can be reused by adding a very small amount of colorant is high.

(4) In the ink replenishment container of the above aspect, the cap may be composed of a recycled resin material having the black-based color.

According to the ink replenishment container of this aspect, since the cap which is easily separated from the ink replenishment container and easily used for a recycled material is composed of a recycled resin material having a black-based color, it is possible to reduce sorting and coloring, and it is possible to easily recycle the cap.

(5) In the ink replenishment container of the above aspect, the cap may be composed of a recycled resin material having the black-based color and optical transparency.

According to the ink replenishment container of this aspect, since the cap is composed of a recycled resin material having a black-based color and optical transparency, it is easy for the user to visually recognize through the cap that ink is attached to the outer surface of the ink outlet portion. This makes it easy to call attention to ink contamination when the user opens the cap. In particular, ink having high chroma can be easily viewed from the outside even through a semi-transparent cap having a black-based color.

(6) In the ink replenishment container of the above aspect, the ink outlet portion may be composed of a recycled resin material having the black-based color.

According to the ink replenishment container of this aspect, since the ink outlet portion is composed of a recycled resin material having a black-based color, the ink outlet portion is suitable for recycling. In addition, when the ink outlet portion has a gray color among the black-based colors, for example, the color can be close to the color of the container body composed of metal, and it is easy to distinguish between the cap which needs to be detached and the ink outlet portion which need not be detached.

(7) In the ink replenishment container of the above aspect, the ink outlet portion may be composed of a recycled resin material having the black-based color and optical transparency.

For example, in a configuration in which a sealing member such as a film is attached to the opening of the container body, it is necessary to remove the sealing member or make a cutout in the sealing member at the time of use. According to the ink replenishment container of this aspect, since the ink outlet portion is composed of a recycled resin material having optical transparency, the sealing member attached can be easily visually recognized from the outside, and this makes it easy to call the user's attention.

(8) In the ink replenishment container of the above aspect, the container body may be composed of a recycled resin material having the black-based color.

According to the ink replenishment container of this aspect, since the container body is composed of a recycled resin material having a black-based color, it is easy to suppress deterioration of the ink contained in the container body due to light such as ultraviolet rays. In addition, since the container body, which typically has a relatively large proportion of the entire ink replenishment container, is composed of a recycled resin material of a black-based color, the percentage of recycled material use can be improved. In addition, when recycling, it is easy to increase the amount of recycled material used, and since the color is black-based, it is suitable for recycling.

(9) In the ink replenishment container of the above aspect, the container body may be composed of a recycled resin material having the black-based color and optical transparency.

According to the ink replenishment container of this aspect, since the container body is composed of a recycled resin material having a black-based color and optical transparency, it is possible to suppress deterioration of the ink contained in the container body due to light such as ultraviolet rays and to make it easy to visually recognize the amount of remaining ink from the outside. In addition, since it is easy to visually recognize that the change in the liquid level in the container body has stopped during an ink supply process, it is possible to easily recognize that the ink supply process has ended.

In addition to the above aspects, the present disclosure can be implemented in aspects such as a method of manufacturing an ink replenishment container.

What is claimed is:

1. An ink replenishment container for supplying ink to an ink ejection apparatus, the ink replenishment container comprising:
a container body configured to contain the ink;
an ink outlet portion coupled to the container body and including an ink outlet through which the ink flows out; and
a cap that is attached to the ink outlet portion and covers the ink outlet, wherein
at least one of the container body, the ink outlet portion, and the cap is composed of a recycled resin material having a black-based color.

2. The ink replenishment container according to claim 1, wherein
the black-based color is an achromatic color having an L* value of 0 or more and less than 50 in an L*a*b* color system in a CIE color system.

3. The ink replenishment container according to claim 2, wherein
the black-based color is an achromatic color having an L* value of 0 or more and less than 10 in the L*a*b* color system in the CIE color system.

4. The ink replenishment container according to claim 1, wherein
the cap is composed of a recycled resin material having the black-based color.

5. The ink replenishment container according to claim 1, wherein
the cap is composed of a recycled resin material having the black-based color and optical transparency.

6. The ink replenishment container according to claim 1, wherein
the ink outlet portion is composed of a recycled resin material having the black-based color.

7. The ink replenishment container according to claim 6, wherein
the ink outlet portion is composed of a recycled resin material having the black-based color and optical transparency.

8. The ink replenishment container according to claim 1, wherein
the container body is composed of a recycled resin material having the black-based color.

9. The ink replenishment container according to claim 8, wherein
the container body is composed of a recycled resin material having the black-based color and optical transparency.
